(19) United States
(12) Patent Application Publication
(10) Pub. No.: US 2011/0261877 A1
(43) Pub. Date: Oct. 27, 2011

(54) STEREOSCOPIC VIDEO ENCODING/DECODING APPARATUSES SUPPORTING MULTI-DISPLAY MODES AND METHODS THEREOF

(75) Inventors: Yunjung CHOI, Daejon (KR); Suk-Hee CHO, Daejon (KR); Kug-Jin YUN, Daejon (KR); Jinhwan LEE, Daejon (KR); Chieteuk AHN, Daejon (KR)

(73) Assignee: ELECTRONICS AND TELECOMMUNICATIONS RESEARCH INSTITUTE, Daejon (KR)

(21) Appl. No.: 13/167,786

(22) Filed: Jun. 24, 2011

Related U.S. Application Data
(63) Continuation of application No. 10/500,352, filed on Jun. 25, 2004.

(30) Foreign Application Priority Data
Dec. 28, 2001 (KR) 2001/86464

(51) Int. Cl. H04N 11/04

(52) U.S. Cl. 375/240.01; 375/E07.026

(57) ABSTRACT

Provided is a stereoscopic video encoding and/or decoding apparatus that supports multi-display modes, the encoding/decoding method thereof and computer-readable recording medium for recording a program that implements the encoding/decoding method. The encoding apparatus of this research incorporates: a field separating means for separating right and left-eye input images into an odd field of the left-eye image (LO), even field of the left-eye image (LE), odd-numbered field (RO) of the right-eye image, and even-numbered field (RE) of the right-eye image; an encoding means for encoding the fields separated in the field separating means by performing motion and disparity compensation; and a multiplexing means for multiplexing the essential fields among the fields received from the encoding means, based on the user display information.

### TECHNICAL FIELD

The present invention relates to a stereoscopic video encoding/decoding apparatus that supports multi-display modes, encoding and/or decoding method thereof, and a computer-readable recording medium for recording a program that implements the method; and, more particularly, to a stereoscopic video encoding/decoding apparatus that supports multi-display modes that make it possible to perform decoding with essential encoding bit stream only needed for a selected stereoscopic display mode, so as to transmit video data efficiently in an environment where a user can select a display mode, encoding and/or decoding method thereof, and a computer-readable recording medium for recording a program to implement the methods

### BACKGROUND ART

Generally, in case of a two-dimensional video image, one-eye images exist on a time axis, whereas in case of a three-dimensional image, two or more-eye images exist on the same time axis. Moving Picture Experts Group-2-Multiview Profile (MPEG-2 MVP) is a conventional method for encoding a stereoscopic three-dimensional video image. The base layer of MPEG-2 MVP has an architecture of encoding one image among right and left-eye images without using the other-eye image. Since the base layer of MPEG-2 MVP has the same architecture as the base layer of conventional MPEG-2 MP (Main Profile), it is possible to perform decoding with a conventional two-dimensional video image decoding apparatus, and applied to a conventional two-dimensional video display mode. That is, MPEG-2 MVP is compatible with the existing two-dimensional video system.

In the MPEG-2 MVP mode, the image-encoding in the enhancement layer uses related information between the right and left-eye images. Accordingly, the MPEG-2 MVP mode has its basis on temporal scalability. Also, it outputs frame-based two-channel bit streams that correspond to the right and left-eye image, respectively, in the bottom and enhancement layers, and the prior art related to a stereoscopic three-dimensional video image encoding is based on the two-layer MPEG-2 MVP encoding.

As for a related prior art, there is ‘Digital 3D/stereoscopic Video Compression Technique Utilizing Two Disparity Estimates’ disclosed in U.S. Pat. No. 5,612,735. The technique of U.S. Pat. No. 5,612,735 uses temporal scalability and encodes a left-eye image using motion compensation and DCT-based algorithm in the base layer, and encodes a right-eye image using disparity information between the base layer and the enhancement layer without any motion compensation between the right-eye image and the left-eye image in the enhancement layer

FIG. 1A is a diagram illustrating a conventional encoding method using disparity compensation, which is disclosed in the above U.S. Pat. No. 5,612,735. I, P, B shown in the drawing denote three screen types defined in the MPEG standard. The screen I (Intra-coded), which exists in the base layer only, is simply encoded without any motion compensation. In screen P (Predicted coded), motion compensation is performed, using the screen I or a screen P. In screen B (Bi-directional predicted coded), motion compensation is performed from two screens that exist before and after the screen B on the time axis.

The encoding order in the base layer is the same as that of the MPEG-2 MP mode. In the enhancement layer, only screen B exists, and the screen B is encoded performing disparity compensation from the frame existing on the same time axis and the screen next to the frame among the screens in the base layer.

Another related prior art is ‘Digital 3D/Stereoscopic Video Compression Technique Utilizing Disparity and Motion Compensated Predictions,’ which is U.S. Pat. No. 5,619,256. The technique of U.S. Pat. No. 5,619,256 uses temporal scalability and encodes a left-eye image using motion compensation and DCT-based algorithm in the base layer, and in the enhancement layer, it uses motion compensation between the right-eye image and the left-eye image and disparity information between the base layer and the enhancement layer.

FIG. 1B is a diagram showing a conventional encoding method using disparity information, which is suggested in U.S. Pat. No. 5,619,256. As described in the drawing, the base layer of the technique is formed in the same base layer estimation method of FIG. 1, the screen P of the enhancement layer performs disparity compensation by estimating the image from the screen I of the base layer. In addition, the screen B of the enhancement layer performs motion and disparity compensation by estimating the image from the previous screen in the same enhancement layer and the screen on the same time axis in the base layer.

In the methods of U.S. Pat. No. 5,612,735 and U.S. Pat. No. 5,619,256, bit stream outputted from the base layer only is transmitted, in case where the reception end uses two-dimensional video display mode, and in case where the reception end uses three-dimensional frame shuttering display mode, all bit stream outputted from both base layer and enhancement layer is transmitted to restore an image in the receiver. If the display mode of the reception end is a three-dimensional video field shuttering display, which is commonly adopted in most personal computers at present, there is a problem that inessential even-numbered field information of the left-eye image and odd-numbered field information of the right-eye image should be transmitted together so as for the reception end to restore a needed image. After all, after the entire received bit stream is decoded, the even-numbered field information of the left-eye image and odd-numbered field information of the right-eye field are abandoned. Therefore, there are serious problems that transmission efficiency is decreased, and the amount of image restoration in the decoding apparatus and the decoding time delay are increased.

Meanwhile, five encoding methods for encoding left and right-eye video images by reducing both right and left-eye images by half, and converting the right and left-eye two-channel images into one-channel image are suggested in ‘3D Video Standards Conversion’ (Andrew Woods, Tom Docherty and Rolf Koch, Stereoscopic Displays and Applications VII, Proceedings of the SPIE vol. 2653A, California, February 1996). In addition, another prior art related to the encoding method suggested in the above paper, ‘Stereoscopic Coding System,’ is disclosed in U.S. Pat. No. 5,633,682.

U.S. Pat. No. 5,633,682 suggests a method performing a conventional two-dimensional video MPEG encoding, using the first image converting method suggested in the above paper. That is, an image is converted into one-channel image by selecting only odd-numbered field for the left-eye image, and only even-numbered field for the right-eye image. The method of U.S. Pat. No. 5,633,682 has an advantage that it uses the conventional two-dimensional video image MPEG encoding method, and in the encoding process, it uses information on the motion and disparity naturally, when a field is estimated. However, there are problems, too. In field estimation, only motion information is used and disparity information goes out of consideration. Also, in case of the screen B, although the most relevant image of screen B is an image on the same time, disparity compensation is carried out by estimating an image out of the screen I or P which exists before or after the screen B and has low relativity, instead of disparity from the image on the same time axis.

In addition, the method of U.S. Pat. No. 5,633,682 adopts a field shuttering method, in which the right and left-eye images are displayed on a three-dimensional video displayer, the right and left images being crossed on a field basis. Therefore, it is not suitable for a frame shuttering display mode where right and left-eye images are displayed simultaneously.

### DISCLOSURE OF INVENTION

It is, therefore, an object of the present invention to provide a stereoscopic video encoding apparatus that supports multi-display modes by outputting field-based bit stream for right and left-eye images, so as to transmit the essential fields for selected display only and minimize the channel occupation by unnecessary data transmission and the decoding time delay.

It is another object of the present invention to provide a stereoscopic video image encoding method supporting multi-display modes by outputting field-based bit stream for right and left-eye images, so as to transmit the essential fields for selected display only and minimize the channel occupation by inessential data transmission and the decoding time delay.

It is another object of the present invention to provide a computer-readable recording medium for recording a program that implements the function of transmitting the essential fields for selected display only and minimizing the channel occupation by unnecessary data transmission and the decoding time delay.

It is another object of the present invention to provide a stereoscopic video decoding apparatus supporting multi-display modes by outputting field-based bit stream for right and left-eye images, so as to restore an image in a requested display mode, even though input bit stream exists with respect to some layer.

It is another object of the present invention to provide a stereoscopic video image decoding method supporting multi-display modes by outputting field-based bit stream for right and left-eye images, so as to restore an image in a requested display mode, even though input bit stream exists with respect to some layer.

It is another object of the present invention to provide a computer-readable recording medium for recording a program that implements the function of restoring an image in a requested display mode, even though input bit stream exists with respect to some layer.

In accordance with one aspect of the present invention, there is provided a stereoscopic video encoding apparatus that supports multi-display modes based on a user display information, comprising: a field separating means for separating right and left-eye input images into an left odd field (LO) composed of odd-numbered lines in the left-eye image, left even field (LE) composed of even-numbered lines in the left-eye image, right odd field (RO) composed of odd-numbered lines in the right-eye image, and right even field (RE) composed of even-numbered lines in the right-eye image; an encoding means for encoding the fields separated in the field separating means by performing motion and disparity compensation; and a multiplexing means for multiplexing the essential fields among the fields received from the encoding means, based on the user display information.

In accordance with another aspect of the present invention, there is provided a stereoscopic video decoding apparatus that supports multi-display modes based on a user display information, comprising: an inverse-multiplexing means for multiplexing supplied bit stream to be suitable for the user display information; a decoding means for decoding the field inverse-multiplexed in the inverse-multiplexing means by performing estimation for motion and disparity compensation; and a display means for displaying an image decoded in the decoding means based on the user display information.

In accordance with another aspect of the present invention, there is provided a method for encoding a stereoscopic video image that supports multi-display mode based on a user display information, comprising the steps of: a) separating right and left-eye input images into left even field (LE) composed of even-numbered lines in the left-eye image, right odd field (RO) composed of odd-numbered lines in the right-eye image, and right even field (RE) composed of even-numbered lines in the right-eye image; b) encoding the fields separated in the above step a) by performing estimation for motion and disparity compensation; and c) multiplexing the essential fields among the fields encoded in the step b) based on the user display information.

In accordance with another aspect of the present invention, there is provided a method for decoding a stereoscopic video image that supports multi-display mode based on a user display information, comprising the steps of: a) inverse-multiplexing supplied bit stream to be suitable for the user display information; b) decoding the fields inverse-multiplexed in the step a) by performing estimation for motion and disparity compensation; and c) displaying an image decoded in the step b) according to the user display information.

In accordance with another aspect of the present invention, there is provided a computer-readable recording medium provided with a microprocessor for recording a program that implements a stereoscopic video encoding method supporting multi-display modes based on a user display information, comprising the steps of: a) separating right and left-eye input images into left even field (LE) composed of even-numbered lines in the left-eye image, right odd field (RO) composed of odd-numbered lines in the right-eye image, and right even field (RE) composed of even-numbered lines in the right-eye image; b) encoding the fields separated in the above step a) by performing estimation for motion and disparity compensation; and c) multiplexing the essential fields among the fields encoded in the step b) based on the user display information.

In accordance with another aspect of the present invention, there is provided a computer-readable recording medium provided with a microprocessor for recording a program that implements a stereoscopic video decoding method supporting multi-display modes based on a user display information, comprising the steps of: a) inverse-multiplexing supplied bit stream to be suitable for the user display information; b) decoding the fields inverse-multiplexed in the step a) by performing estimation for motion and disparity compensation; and c) displaying an image decoded in the step b) according to the user display information.

The present invention relates to a stereoscopic video encoding and/or decoding process that uses motion and disparity compensation. The encoding apparatus of the present invention inputs odd and even fields of right and left-eye images into four encoding layers simultaneously and encodes them using the motion and disparity information, and then multiplexes and transmits only essential channels among the bit stream encoded according to four-channel fields based on the display mode selected by a user. The decoding apparatus of the present invention can restore an image in a requested display mode, even though bit stream exists only in some of the four layers, after performing inverse multiplexing on a received signal.

In case where a three-dimensional video field shuttering and two-dimensional video display modes are used, an MPEG-2 MVP-based stereoscopic three-dimensional video encoding apparatus, which performs decoding by using all the two encoding bit stream outputted from the base layer and the enhancement layer, can carry out decoding only when all data are transmitted, even though half of the transmitted data should be thrown away. For this reason, transmission efficiency is decreased and decoding time is delayed long.

On the other hand, the encoding apparatus of the present invention transmits the essential fields for display only, and the decoding apparatus of the present invention performs decoding with the transmitted essential fields, thus minimizing the channel occupation by inessential and the delay in decoding time.

The encoding and/or decoding apparatus of the present invention adopts a multi-layer encoding, which is formed of a total of four encoding layers by inputting odd and even-numbered fields of both right and left-eye images.

The four layers forms a main layer and a sub-layer according to the relation estimation of the four layers. The decoding apparatus of the present invention can perform decoding and restore an image just with encoding bit stream for a field corresponding to a main layer. The encoding bit stream for a field corresponding to a sub-layer cannot be decoded as it is alone, but can be decoded by depending on the bit stream of the main layer and the sub-layer.

The main layer and the sub-layer can have two different architectures according to the display mode of the encoding and/or decoding apparatus.

A first architecture performs encoding and/or decoding based on a video image field shuttering display mode. In this architecture, the odd field of the left-eye (LO) image and the even field of the right-eye (RE) image are encoded in the main layer, and the remaining even field of the left-eye image (LE) is encoded in a first sub-layer, while the odd field of the right-eye image (RO) is encoded in a second sub-layer.

In case of a field shuttering display mode, the four-channel bit stream that is encoded in each layer and outputted therefrom in parallel, and the two-channel bit stream outputted from the main layer is multiplexed and transmitted. In case where a user converts the display mode into a three-dimensional video frame shuttering display mode, the bit stream outputted from the first and second sub-layers is multiplexed additionally and then transmitted.

The second architecture supports the two-dimensional video image display mode efficiently, as well as the field and frame display mode. This architecture performs encoding and/or decoding independently, taking the odd field of the left-eye image (LE) as its main layer, and the remaining even-numbered field of the right-eye image as a first sub-layer, the even field of the left-eye image (LE) as a second sub-layer, and the odd field of the right-eye image (RO) as the third sub-layer. The sub-layers use information of the main layer and the other sub-layers.

Regardless of a display mode, the odd-numbered bit stream of the left-eye image encoded in the main layer is transmitted basically, and in case where a user uses a three-dimensional field shuttering display mode, the bit stream outputted from the main layer and the first sub-layer is transmitted after multiplexed. In case where the user uses a three-dimensional frame shuttering display mode, the bit stream output from the main layer and the other three sub-layers is transmitted after multiplexed. In addition, in case where the user uses a two-dimensional video display mode, the bit stream outputted from the main layer and the second sub-layer is transmitted to display the left-eye image only.

This method has a shortcoming that it cannot use all the field information in the encoding and/or decoding of the sub-layers, but it is useful, especially when a user sends a three-dimensional video image to another user who does not have a three-dimensional display apparatus, because the user can convert the three-dimensional video image into a two-dimensional video image.

Therefore, the encoding and/or decoding apparatus of the present invention can enhance transmission efficiency, and simplify the decoding process to reduce the overall display delay by transmitting the essential bit stream only according to the three video image display modes, i.e., a two-dimensional video image display mode, three-dimensional video image field shuttering modes, and three-dimensional video image frame shuttering mode, and performing decoding, when encoded bit stream is transmitted.

### BRIEF DESCRIPTION OF DRAWINGS

The above and other objects and features of the present invention will become apparent from the following description of the preferred embodiments given in conjunction with the accompanying drawings, in which:

FIG. 1A is a diagram illustrating a conventional encoding method using estimation for disparity compensation;

FIG. 1B is a diagram depicting a conventional method using estimation for motion and disparity compensation;

FIG. 2 is a structural diagram describing a stereoscopic video encoding apparatus that supports multi-display modes in accordance with an embodiment of the present invention;

FIG. 3 is a diagram showing a field separator of FIG. 2 separating an image into a right-eye image and a left-eye image in accordance with the embodiment of the present invention;

FIG. 4A is a diagram describing the encoding process of an encoder shown in FIG. 2, which supports three-dimensional video display in accordance with the embodiment of the present invention;

FIG. 4B is a diagram describing the encoding process of the encoder shown in FIG. 2, which supports two and three-dimensional video display in accordance with the embodiment of the present invention;

FIG. 5 is a structural diagram illustrating a stereoscopic video decoding apparatus that supports multi-display modes in accordance with the embodiment of the present invention;

FIG. 6A is a diagram describing a three-dimensional field shuttering display mode of a displayer shown in FIG. 5 in accordance with the embodiment of the present invention;

FIG. 6B is a diagram describing a three-dimensional frame shuttering display mode of the displayer shown in FIG. 5 in accordance with the embodiment of the present invention;

FIG. 6C is a diagram describing a two-dimensional display mode of the displayer shown in FIG. 5 in accordance with the embodiment of the present invention;

FIG. 7 is a flow chart illustrating a stereoscopic video encoding process that supports multi-display modes in accordance with the embodiment of the present invention; and

FIG. 8 is a flow chart illustrating a stereoscopic video decoding process that supports multi-display modes in accordance with the embodiment of the present invention.

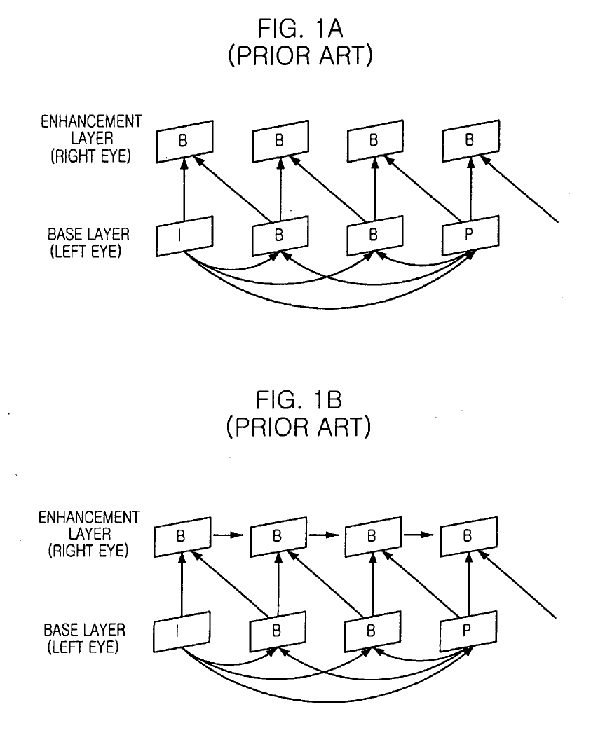

### BEST MODE FOR CARRYING OUT THE INVENTION

Other objects and aspects of the invention will become apparent from the following description of the embodiments with reference to the accompanying drawings, which is set forth hereinafter.

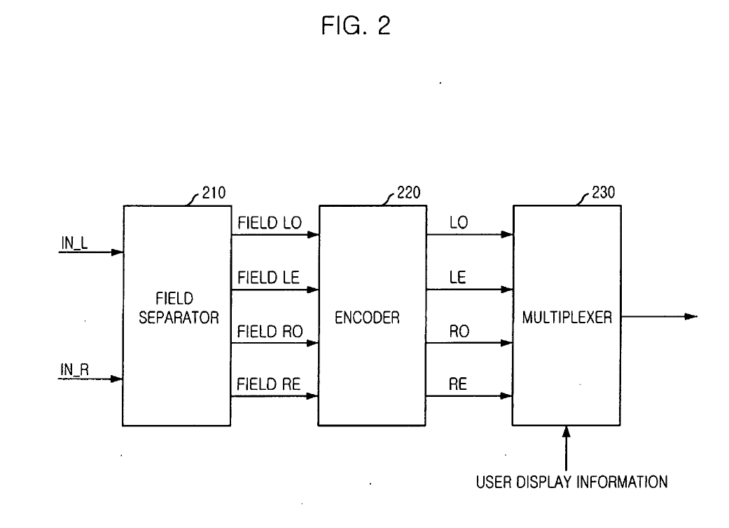

FIG. 2 shows a structural diagram describing a stereoscopic video encoding apparatus that supports multi-display modes in accordance with an embodiment of the present invention. As illustrated in the drawing, the encoding apparatus of the present invention includes a field separator 210, an encoder 220, and a multiplexer 230.

The field separator 210 performs the function of separating two-channel right and left-eye images into odd-numbered fields and even-numbered fields, and converting them into four-channel input images.

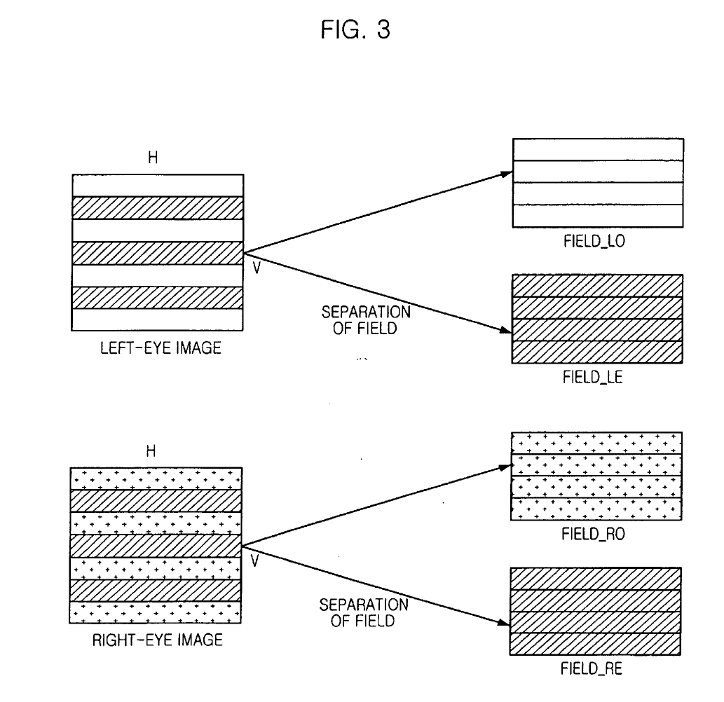

FIG. 3 shows an exemplary diagram of a field separator separating an image into odd and even fields in the right and left-eye images, respectively. As shown in the drawing, the field separator 210 of the present invention separates a one-frame image for the right eye or the left-eye into odd-numbered lines and even-numbered lines and converts them into field images. In the drawing, H denotes the horizontal length of an image, while V denotes the vertical length of the image. The field separator 210 separates an input image into field-based four layers, and thus forms a multi-layer encoding structure by taking a frame-based image as its input data, and a motion and disparity estimation structure for transmitting only the essential bit stream according to the display mode.

The encoder 220 performs the function of encoding an image received from the field separator 210 by using estimation to compensate motion and disparity. The encoder 220 is formed of a main layer and a sub-layer that receive the four-channel odd-numbered fields and even-numbered fields separated from the field separated 210, and carries out the encoding.

The encoder 220 uses a multi-layer encoding method, in which the odd-numbered fields and even-numbered fields of the right-eye image and the left-eye image are inputted from four encoding layers. The four layers are formed into a main layer and a sub-layer according to relation estimation of the fields, and the main layer and the sub-layer have two different architectures according to a display mode that an encoder and/or a decoder tries to support.

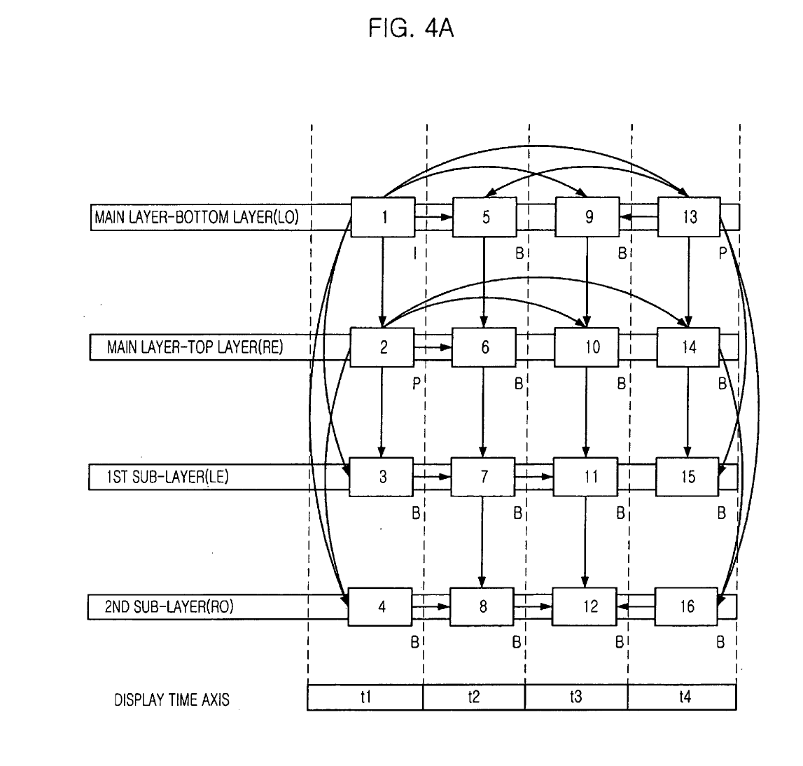

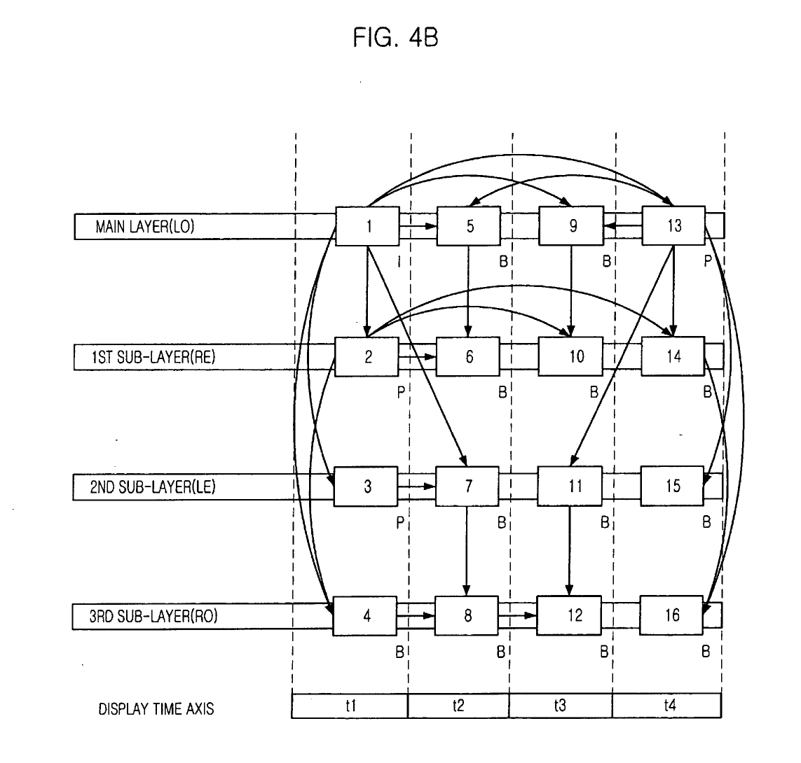

FIG. 4A is a diagram describing the encoding process of an encoder shown in FIG. 2, which supports three-dimensional video display in accordance with the embodiment of the present invention. As illustrated in the drawing, the field-based stereoscopic video image encoding apparatus of the present invention that makes a estimation to compensate motion and disparity is formed of a main layer and first and second sub-layers. The main layer is formed of the odd field of a left-eye image (LO) and the even field of a right-eye image (RE), which are essential for a field shuttering display mode, and the first sub-layer is formed of the even field of the left-eye image (LE) and the second sub-layer is formed of the odd field of a right-eye image (RO).

The main layer composed of the odd field of the left-eye image (LO) and the even field of a right-eye image (RE) uses the odd field of a left-eye image (LO) as its base layer and the even field of the right-eye image (RE) as its enhancement layer, and performs encoding by making a estimation for motion and disparity compensation. Thus, the main layer is formed similar to the conventional MPEG-2 MVP that is composed of the base layer and the enhancement layer.

The first sub-layer uses the information related to the base layer or the enhancement layer, while the second sub-layer uses the information related not only to the main layer, but also to the first sub-layer.

In FIG. 4A, a field 1 with respect to the base layer at a display time t1 is encoded into a field I, and a field 2 with respect to the enhancement layer is encoded into a field P by performing disparity estimation based on the field 1 of the base layer that exists on the same time axis. A field 3 of the first sub-layer uses motion estimation based on the field 1 of the base layer and disparity estimation based on the field 3 of the enhancement layer. A field 4 of the second sub-layer uses disparity estimation based on the field 1 of the base layer and motion estimation based on the field 2 of the enhancement layer.

Now performed is encoding of the fields existing at a display time t4 in each layer. In other words, a field 13 with respect to the base layer is encoded into a field P by performing motion estimation based on the field 1, and a field 14 with respect to the enhancement layer is encoded into a field B by performing motion estimation based on the field 2 and disparity estimation based on the field 13 of the base layer on the same time axis.

A field 15 of the first sub-layer uses motion estimation based on the field 13 of the base layer and disparity estimation based on the field 14 of the enhancement layer. A field 16 of the second sub-layer uses disparity estimation based on the field 13 of the base layer and motion estimation based on the field 14 of the enhancement layer.

The fields in the respective layers are encoded in the order of a display time t2, t3, and so on. That is, a field 5 with respect to the base layer is encoded into a field B by performing motion estimation based on the fields 1 and 13. A field 6 with respect to the enhancement layer is encoded into a field B by performing disparity estimation based on the field 5 of the base layer on the same time axis and motion estimation based on the field 2 of the same layer. A field 7 of the first sub-layer is encoded by performing motion estimation based on the field 3 of the same layer and disparity estimation based on the field 6 of the enhancement layer. A field 8 of the second sub-layer uses motion estimation based on the field 4 of the same layer and disparity estimation based on the field 7 of the first sub-layer.

A field 9 with respect to the base layer is encoded into a field B by performing motion estimation based on the fields 1 and 13. A field 10 with respect to the enhancement layer is encoded into a field B by performing disparity estimation based on the field 9 of the base layer on the same time axis and motion estimation based on the field 2 of the same layer.

A field 11 of the first sub-layer uses motion estimation based on the field 7 of the same layer, and disparity estimation based on the field 10 of the enhancement layer. A field 12 of the second sub-layer uses motion estimation based on the field 8 of the same layer, and disparity estimation based on the field 11 of the first sub-layer.

Accordingly, in the bottom and enhancement layers of the main layer, encoding is carried out in the form of IBBP^{•••} and PBBB^{•••}, and the first and second sub-layers are all encoded in the form of a field B. Since the first and second sub-layers are all encoded into a field B in the encoder 220 by performing motion and disparity estimation from the fields in the bottom and enhancement layers of the main layer on the same time axis, estimation liability becomes high and the accumulation of encoding error can be prevented.

FIG. 4B is a diagram describing the encoding process of the encoder shown in FIG. 2, which supports two and three-dimensional video display in accordance with the embodiment of the present invention. The encoding process of FIG. 4B supports a two-dimensional video image display mode as well as a field shuttering display mode and a frame shuttering display mode. As illustrated in the drawing, the main layer of the encoder of the present invention is formed independently of the odd field of a left-eye image (LO) only.

The first sub-layer is formed of the even field of a right-eye image (RE), and the second sub-layer and the third sub-layer are formed of the even field of the left-eye image (LE) and the odd-numbered field (RO) of the right-eye image, respectively. The sub-layers are formed to perform encoding and/or decoding using the main layer information and sub-layer information related to each other.

That is, in case where a field shuttering display mode is requested, encoding can be carried out only with the bit stream encoded in the main layer and the second sub-layer, and in case where a the frame shuttering display mode is required, encoding can be performed with the bit stream in all layers. In case where a two-dimensional video image display mode is required, encoding can be carried out only with the bit stream encoded in the main layer and the first sub-layer.

Accordingly, the fields of the main layer uses the motion information between the fields in the main layer, and the first sub-layer uses motion information between the fields in the same layer and disparity information with the fields of the main layer. The second sub-layer uses only motion information with the fields of the same layer and the main layer, and does not use disparity information with the fields in the first sub-layer. The first and second sub-layers are formed to depend on the main layer only. Finally, the third sub-layer is formed to depend on all the layers, using motion and disparity information with the fields of the entire layers.

In FIG. 4B, decoding is carried out hierarchically, based on the time axis, just as shown in FIG. 4A. First, a field 1 of the main layer that exists at a display time t1 is encoded into a field I, and a field 2 of the first sub-layer is encoded into a field P by performing disparity estimation based on the field 1 of the main layer on the same time axis. A field 3 of the second sub-layer is encoded into a field P by performing motion estimation based on the field 1 of the main layer. A field 4 of the third sub-layer uses disparity estimation based on the field 1 of the main layer and motion estimation based on the field 2 of the first sub-layer.

The fields of the respective layers that exist at a display time t4 are encoded as follows. That is, a field of the main layer is encoded into a field P by performing motion estimation based on the field 1. A field 14 of the first sub-layer is encoded into a field B by performing disparity estimation based on the field 13 of the main layer on the same time axis and motion disparity based on the field 2 of the same layer.

A field 15 of the second sub-layer is encoded into a field B by performing motion estimation based on the field 13 of the main layer and the field 3 of the same layer. A field 16 of the third sub-layer is encoded into a field B by performing disparity estimation based on the field 13 of the main layer and motion disparity based on the field 14 of the first sub-layer.

The fields of the respective layers are encoded in the order of a display time t2, t3, and so on. In other words, a field 5 of the main layer is encoded into a field B by performing motion estimation based on the fields 1 and 13 of the same layer, and a field 6 of the first sub-layer is encoded into a field B by performing disparity estimation based on the field 5 of the main layer on the same time axis and motion estimation based on the field 2 of the same layer.

A field 7 of the second sub-layer is encoded into a field B by performing motion estimation based on the field 3 of the same layer and the field 1 of the main layer. A field 8 of the third sub-layer is encoded using motion estimation based on the field 4 of the same layer and disparity estimation based on the field 7 of the second sub-layer.

A field 9 of the main layer is encoded into a field B by performing motion estimation based on the fields 1 and 13. A field 10 of the first sub-layer is encoded into a field B by performing disparity estimation based on the field 9 of the main layer on the same time axis and motion estimation based on the field 14 of the same layer.

In addition, a field 11 of the second sub-layer is encoded into a field B by performing motion estimation based on the field 3 of the same layer and the field 13 of the main layer. A field 12 of the third sub-layer is encoded by performing motion estimation based on the field 8 of the same layer and disparity estimation based on the field 11 of the second sub-layer. Accordingly, in the main layer, the fields are encoded in the form of IBBP^{•••}, and in the first, second, and third sub-layers, the fields are encoded in the form of PBBB^{•••}, PBBB^{•••} and BBB^{•••}, respectively.

The encoder 220 can prevent the accumulation of encoding errors, because the fields in the first, second, and third sub-layers perform motion and disparity estimation at a time t4 from the fields in the main layer and the first sub-layer on the same time axis and are encoded into a field B. Since it can decode the left-eye image field layers separately from the right-eye image field layers, the encoder 220 can support a two-dimensional display mode, which uses left-eye images only, efficiently.

The multiplexer 230 receives an odd-numbered field (LO) of a left-eye image, an even field of a right-eye image (RE), an even field of a left-eye image (LE), and an odd field of a right-eye image (RO), which correspond to four field-based bit stream, from the encoder 220, and then it receives information on the user display mode from a reception end (not shown) and multiplexes only the essential bit stream for display.

In short, the multiplexer 230 perform multiplexing to make bit stream suitable for three display modes. In case of a mode 1 (i.e., a three-dimensional field shuttering display), multiplexing is performed on the LO and RE that correspond to half of the right and left information. In case of a mode 2 (i.e., a three-dimensional video frame shuttering display), multiplexing is carried out on the encoding bit stream corresponding to the four fields, which are LO, LE, RO, and RE, since it uses all the information in the right and left frames. In case of a mode 3 (i.e., a two-dimensional video display), multiplexing is performed on the fields LO, LE to express the left-eye image among the right and left-eye images.

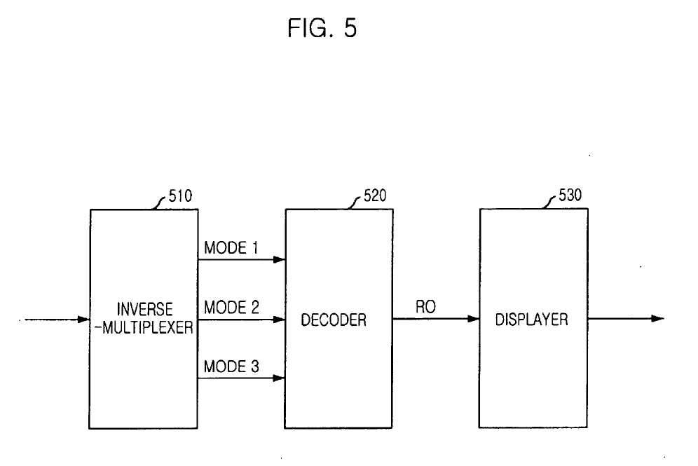

FIG. 5 is a structural diagram illustrating a stereoscopic video decoding apparatus that supports multi-display modes in accordance with the embodiment of the present invention. As illustrated in the drawing, the decoder of the present invention includes an inverse multiplexer 510, a decoder 520, and a displayer 530.

The inverse multiplexer 510 performs inverse-multiplexing to make the transmitted bit stream suitable for the user display mode, and output them into multi-channel bit stream. Accordingly, the mode 1 and mode 3 should output two-channel field-based encoded bit stream, and the mode 2 should output four-channel field-based encoded bit stream.

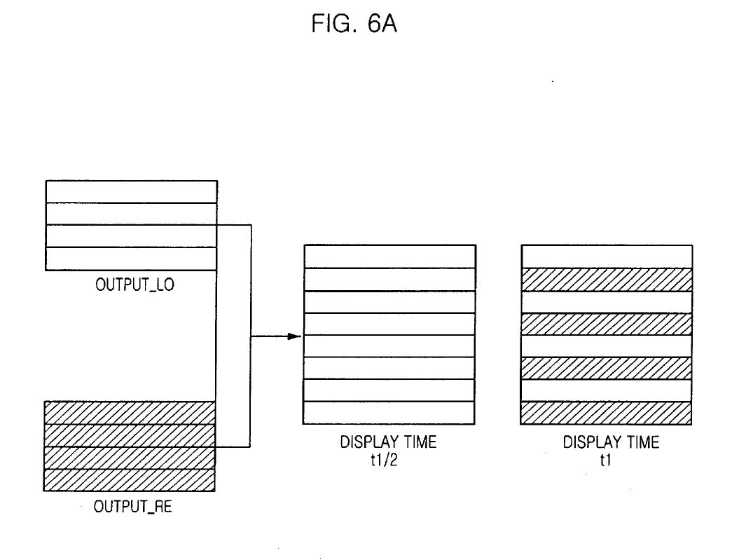

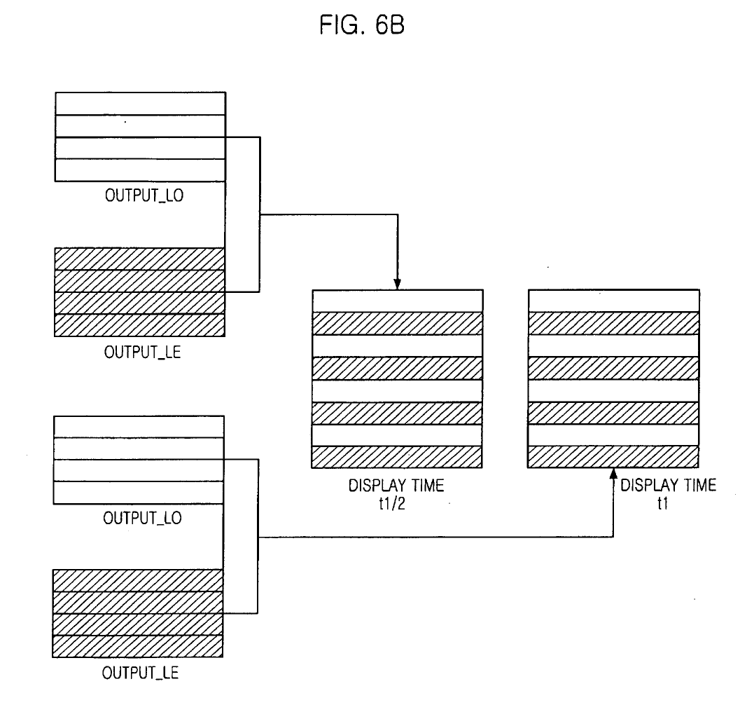

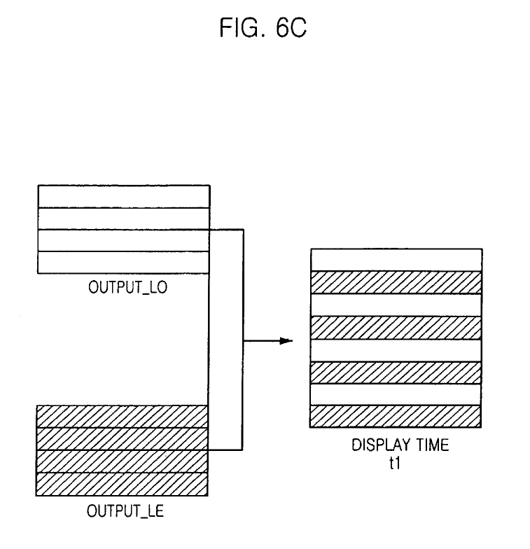

The decoder 520 decodes the field-based bit stream that is inputted in two channels or four channels from the inverse multiplexer 510 by performing estimation to compensate motion and disparity. The decoder 520 has the same layer architecture as the encoder 220, and performs the inverse function of the encoder 220. The displayer 530 carries out the function of displaying the image that is restored in the decoder 520. The decoding apparatus of the present invention can perform decoding depending on the selection of a user among two-dimensional video display mode, three-dimensional video field shuttering display mode, and three-dimensional video frame shuttering display mode, as illustrated in FIGS. 6A through 6C.

FIG. 6A is a diagram describing a three-dimensional field shuttering display mode of a displayer shown in FIG. 5 in accordance with the embodiment of the present invention. As described in the drawing, the displayer 530 of the present invention displays the output_LO that is restored from the odd-numbered field of a left-eye image and the output_RE that is restored from the even-numbered field of a right-eye image in the decoder 520 at a time t1/2 and t1, sequentially.

FIG. 6B is a diagram describing a three-dimensional frame shuttering display mode of the displayer shown in FIG. 5 in accordance with the embodiment of the present invention. As shown in the drawing, the displayer 530 of the present invention displays the output_LO and output_LE that are restored from the odd and even-numbered fields of a left-eye image in the decoder 520 at a time t1/2, and displays the output_RO and output_RE that are restored from the odd and even-numbered fields of a right-eye image at a time t1, sequentially.

FIG. 6C is a diagram describing a two-dimensional display mode of the displayer shown in FIG. 5 in accordance with the embodiment of the present invention. As shown in the drawing, the displayer 530 of the present invention displays the output_LO and output_LE that are restored from the left-eye image only in the decoder 520 at a time t1.

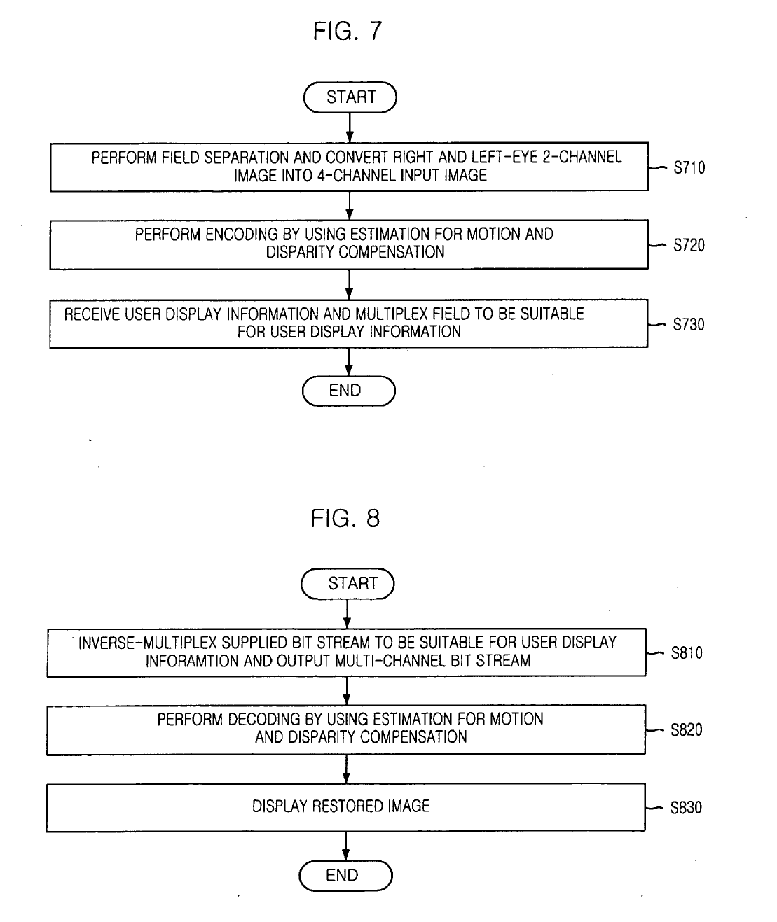

FIG. 7 is a flow chart illustrating a stereoscopic video encoding method that supports multi-display modes in accordance with the embodiment of the present invention.

At step S710, the right and left-eye two-channel images are separated into odd-numbered fields and even-numbered fields, respectively, and converted into a four-channel input image.

At step S720, the converted image is encoded by performing estimation to compensate the motion and disparity. Subsequently, at step S730, information on a user display mode is received from the reception end, and the odd field of a left-eye image (LO), even of a right-eye image (RE), even field of the left-eye image (LE), and odd field of the right-eye image (RO), which correspond the four-channel field based encoded bit stream, are multiplexed suitable for the user display mode.

FIG. 8 is a flow chart illustrating a stereoscopic video decoding method that supports multi-display modes in accordance with the embodiment of the present invention.

At step S810, the transmitted bit stream is inverse-multiplexed to be suitable for the user display mode, and outputted into multi-channel bit stream. Accordingly, in case of the mode 1 (i.e., a three-dimensional field shuttering display) and the mode 3 (i.e., a two-dimensional display), two-channel field-based encoded bit stream is outputted, and in case of the mode 2 (i.e., a three-dimensional video frame shuttering display), four-channel field-based encoded bit stream is outputted.

Subsequently, at step S820, the two-channel or four-channel field-based bit stream outputted in the above process is decoded by performing estimation for motion and disparity compensation, and, at step S830, the restored image is displayed. The decoding method of the present invention is performed according to the user's selection among the two-dimensional video display, three-dimensional video field shuttering display, and three-dimensional video frame shuttering display.

The method of the present invention described in the above can be embodied as a program and stored in a computer-readable recording medium, such as CD-ROM, RAM, ROM, floppy disk, hard-disk, optical-magnetic disk, and the like. The method of the present invention transmits the essential bit stream only based on a user display, mode among three display modes, i.e., a three-dimensional video field shuttering display, three-dimensional video frame shuttering display, and two-dimensional video display, and performs decoding only with the field-based bit stream that are inputted from the reception end, by separating a stereoscopic video image into four field-based stream that correspond to the odd and even-numbered fields of the right and left-eye images, and encoding and/or decoding them into a multi-layer architecture using motion and disparity compensation.

In addition, the method of this invention can enhance transmission efficiency and simplify the decoding process to minimize display time delay caused by the user's request for changing the display mode, by transmitting the essential bit stream for the display mode only.

While the present invention has been described with respect to certain preferred embodiments, it will be apparent to those skilled in the art that various changes and modifications may be made without departing from the scope of the invention as defined in the following claims.

1. A stereoscopic video encoding apparatus that supports multi-3D display modes based on an user 3D display information, comprising:
a field separator for separating right and left-eye input images into an odd field of the left-eye image (LO), even field of the left-eye image (LE), odd field of the right-eye image (RO), and even field of the right-eye image (RE);
an encoder for encoding the fields separated in the field separating means into encoded fields; and
a multiplexer for selecting fields to be transmitted among the encoded fields based on the user 3D display information and multiplexing the selected fields.

2. The stereoscopic video encoding apparatus as recited in claim 1, wherein the user 3D display information includes a three-dimensional field shuttering display mode and a three-dimensional frame shuttering display mode.

3. The stereoscopic video encoding apparatus as recited in claim 1, wherein the multiplexer multiplexes the odd field of the left-eye image (LO) and the even field of the right-eye image (RE), in case where the user 3D display information indicates a three-dimensional field shuttering display mode.

4. The stereoscopic video encoding apparatus as recited in claim 1, wherein the multiplexer multiplexes the odd field of the left-eye image (LO), the even field of the left-eye image (LE), the odd field of the right-eye image (RO), and the even field of the right-eye image (RE), in case where the user 3D display information indicates a three-dimensional frame shuttering display mode.

5. The stereoscopic video encoding apparatus as recited in claim 1, wherein the multiplexer multiplexes the odd field of the left-eye image (LO), and even field of the left-eye image (LE), in case where the user 3D display information indicates a two-dimensional display.

6. The stereoscopic video encoding apparatus as recited in claim 1, wherein the encoder forms the main layer with the odd field of the left-eye image (LO) and the even field of the right-eye image (RE), a first sub-layer with the even field of the left-eye image (LE), and a second sub-layer with the odd field of the right-eye image (RO).

7. The stereoscopic video encoding apparatus as recited in claim 6, wherein the encoder forms the base layer of the main layer with the odd field of the left-eye image (LO) and forms the enhancement layer of the main layer with the even field of the right-eye image (RE), and then performs encoding using estimation for motion and disparity compensation.

8. The stereoscopic video encoding apparatus as recited in claim 6, wherein the first sub-layer performs the estimation for motion compensation based on the information related to the base layer, and performs the estimation for disparity compensation based on the information related to the enhancement layer.

9. The stereoscopic video encoding apparatus as recited in claim 6, wherein the second sub-layer performs the estimation for disparity compensation based on the information related to the base layer, and performs the estimation for motion compensation based on the information related to the enhancement layer.

10. A stereoscopic video decoding apparatus that supports multi-3D display modes based on an user 3D display information, comprising:
an inverse-multiplexer for receiving bitstream including essential fields for a user 3D display mode requested based on the 3D display information and inverse-multiplexing the bit stream;
a decoder for decoding the fields inverse-multiplexed; and
a display means for displaying an image decoded in the decoder according to the user 3D display mode.

11. The stereoscopic video decoding apparatus as recited in claim 10, wherein the user 3D display information includes a three-dimensional field shuttering display mode and a three-dimensional frame shuttering display mode.

12. The stereoscopic video decoding apparatus as recited in claim 10, wherein the inverse-multiplexer inverse-multiplexes the bit stream into the odd field of the left-eye image (LO) and the even field of the right-eye image (RE), in case where the user 3D display mode indicates a three-dimensional field shuttering display.

13. The stereoscopic video decoding apparatus as recited in claim 10, wherein the inverse-multiplexer inverse-multiplexes the bit stream into the odd field of the left-eye image (LO), even field of the left-eye image (LE), odd field of the right-eye image (RO), and the even field of the right-eye image (RE), in case where the user 3D display mode indicates a three-dimensional frame shuttering display mode.

14. The stereoscopic video decoding apparatus as recited in claim 10, wherein the inverse-multiplexer inverse-multiplexes the bit stream into the odd field of the left-eye image (LO), and even field of the left-eye image (LE), in case where the user 3D display mode indicates a two-dimensional display mode.

15. The stereoscopic video decoding apparatus as recited in claim 10, wherein the display means displays an image that is decoded from the odd field of the left-eye image (LO), and an image that is decoded from the even field of the right-eye image (RE) at predetermined time intervals, in case where the user 3D display mode indicates a three-dimensional field shuttering display mode.

16. The stereoscopic video decoding apparatus as recited in claim 10, wherein the display means displays an image that is decoded from the odd field of the left-eye image (LO), an image decoded from the even field of the left-eye image (LE), an image decoded from the odd field of the right-eye image (RO), and an image decoded from the even field of the right-eye image (RE) at predetermined time intervals, in case where the user 3D display mode indicates a three-dimensional frame shuttering display mode.

17. The stereoscopic video decoding apparatus as recited in claim 10, wherein the display means displays an image that is decoded from the odd field of the left-eye image (LO), and an image decoded from the even field of the left-eye image (LE) simultaneously, in case where the user 3D display mode indicates a two-dimensional display mode.

18. A method for encoding a stereoscopic video image that supports multi-3D display modes based on an user 3D display information, comprising the steps of:
a) separating right and left-eye input images into an odd field of the left-eye image (LO), even field of the left-eye image (LE), odd field of the right-eye image (RO), and even field of the right-eye image (RE);
b) encoding the fields separated in the field separating means into encoded fields; and
c) selecting fields to be transmitted among the encoded fields based on the user 3D display information and multiplexing the selected fields.

19. A method for decoding a stereoscopic video image that supports multi-3D display modes based on an user 3D display information, comprising the steps of
a) receiving bitstream including essential fields for a user 3D display mode requested based on the 3D display information and inverse-multiplexing the bit stream;
b) decoding the fields inverse-multiplexed; and
c) displaying an image decoded in the decoder according to the user 3D display mode.
